(19) United States
(12) Patent Application Publication
(10) Pub. No.: US 2026/0309268 A1
(43) Pub. Date: Oct. 8, 2026

(54) TILT ADJUSTMENT MECHANISM AND MOUNTING BRACKET

(71) Applicant: Xinadda (Hong Kong) Limited, Hong Kong (CN)

(72) Inventors: Hao XU, Hong Kong (CN); Lei SUN, Hong Kong (CN)

(73) Assignee: Xinadda (Hong Kong) Limited, Hong Kong (CN)

(21) Appl. No.: 19/234,942

(22) Filed: Jun. 11, 2025

(30) Foreign Application Priority Data
Apr. 7, 2025 (CN) 202520639503.7

(51) Int. Cl. F16M 11/20; F16M 11/04; F16M 11/08

(52) U.S. Cl. CPC F16M 11/2021; F16M 11/048; F16M 11/08; F16M 11/2085

(57) ABSTRACT

The present disclosure provides a tilt adjustment mechanism and a mounting bracket. The tilt adjustment mechanism includes an adjustment hole and an adjustment rod. The adjustment hole includes at least two adjustment sub-holes arranged along a front-rear direction of the tilt adjustment mechanism. The adjustment rod includes a flattened portion, which includes a cylindrical surface and two planes located on opposite sides of the cylindrical surface. A diameter of the cylindrical surface is equal to a diameter of the adjustment sub-holes, and a distance between the two planes is less than or equal to a width of the connecting portion between two adjacent adjustment sub-holes. When the adjustment rod is rotated to a first position, the adjustment rod can pass through the connecting portion between two adjacent adjustment sub-holes. When the adjustment rod is rotated to a second position, the adjustment rod is locked relative to the adjustment hole.

### CROSS-REFERENCE TO RELATED APPLICATIONS

This application claims priority under 35 U.S.C. § 119(a) to Chinese Application Patent Application No. 202520639503.7, filed on Apr. 7, 2025, the entire disclosure of which is hereby incorporated by reference.

### TECHNICAL FIELD

The present disclosure relates to technical fields of display mounting, and in particular relates to a tilt adjustment mechanism and mounting bracket.

### BACKGROUND

Flat-panel TVs, flat-panel displays, and other display devices have been widely adopted due to their advantages such as high resolution, large screens, and lightweight design. Typically, these flat-panel TVs or displays are mounted on walls using wall mounts to save space. However, most existing wall mounts rely on stepless adjustment mechanisms for tilt angle adjustment, which often results in poor locking performance.

### SUMMARY

In view of this, the present disclosure provides a tilt adjustment mechanism and a mounting bracket having the tilt adjustment mechanism, to solve at least one of the above technical problems.

In a first aspect, the present disclosure provides a tilt adjustment mechanism, including a first structural member, and a second structural member. A first sidewall of the first structural member can define a first connection hole and a second connection hole. A second sidewall of the second structural member can define a first pivot hole and an adjustment hole. The adjustment hole can include at least two adjustment sub-holes arranged along a front-rear direction of the tilt adjustment mechanism. A distance between centers of any two adjacent adjustment sub-holes is smaller than a diameter of a single adjustment sub-hole, with each adjustment sub-hole corresponding to a distinct tilt angle. The tilt adjustment mechanism can further include a connecting member and an adjustment rod. The connecting member is connected between the first connection hole and the first pivot hole, and the adjustment rod is penetrated between the adjustment hole and the second connection hole. The adjustment rod can include a flattened portion, which can include a cylindrical surface and two planes located on opposite sides of the cylindrical surface respectively. A diameter of the cylindrical surface is equal to a diameter of the adjustment sub-holes, and a distance between the two planes is less than or equal to a width of a connecting portion between two adjacent adjustment sub-holes. When the adjustment rod is rotated to a first position, the adjustment rod can pass through the connecting portion between two adjacent adjustment sub-holes. When the adjustment rod is rotated to a second position, the adjustment rod is locked relative to the adjustment hole.

In a second aspect, the present disclosure provides a mounting bracket, including a wall plate, a support arm, a tilt adjustment mechanism, a panel, and a mounting member. The wall plate is configured for mounting on a wall. One end of the support arm is pivotally connected to the wall plate. The tilt adjustment mechanism is connected between the other end of the support arm and the panel. The mounting member is configured for fixedly connecting to a back of a display device and hanging on the panel. The tilt adjustment mechanism is the tilt adjustment mechanism described in the first aspect.

Therefore, in the present disclosure, the first position refers to a position where the two planes of the flattened portion of the adjustment rod are approximately oriented toward the arc surfaces of the adjustment sub-holes. Therefore, when the adjustment rod is rotated to the first position, the flattened portion of the adjustment rod can pass through the connecting portion between two adjacent adjustment sub-holes, allowing the adjustment rod to slide along the front-rear direction of the tilt adjustment mechanism within the adjustment hole to adjust the tilt angle of the second structural member relative to the first structural member. The second position refers to a position where the two planes of the flattened portion of the adjustment rod are approximately oriented toward the connecting portion between two adjacent adjustment sub-holes. Therefore, when the adjustment rod is rotated to the second position, the cylindrical surface of the flattened portion fits with the arc surfaces of the adjustment sub-holes, and the planes of the flattened portion face the connecting portion between two adjacent adjustment sub-holes, preventing the adjustment rod from passing through the connecting portion along the front-rear direction of the tilt adjustment mechanism within the adjustment hole. Thus, the adjustment rod is locked relative to the adjustment hole. As a result, the mounting bracket of the present disclosure can achieve stepwise adjustment of the tilt angle, is easy to lock, and ensures that the tilt angle of the mounting bracket does not change under the gravitational force of the display device after adjustment, improving the locking reliability of the tilt angle.

### BRIEF DESCRIPTION OF THE ACCOMPANYING DRAWINGS

To describe the technology solutions in the embodiments of the present disclosure more clearly, the following briefly introduces the accompanying drawings required for describing the embodiments. Obviously, the accompanying drawings in the following description show merely at least one embodiment of the present disclosure, those of ordinary skill in the art may also obtain other drawings based on these drawings without any creative efforts.

FIG. 1 is a perspective view of a mounting bracket for mounting a display device according to embodiments of the present disclosure;

FIG. 2 is a perspective view showing the mounting bracket for mounting the display device in another view according to embodiments of the present disclosure when the mounting bracket is in an unfolded state;

FIG. 3 is a perspective view showing the mounting bracket for mounting the display device in another view according to embodiments of the present disclosure when the mounting bracket is in a folded state;

FIG. 4 is a perspective view of a tilt adjustment mechanism according to a first embodiment of the present disclosure;

FIG. 5 is an exploded view of FIG. 4;

FIG. 6 is a further exploded view of partial components of the tilt adjustment mechanism according to embodiments of the present disclosure;

FIG. 7 is an exploded and partially enlarged view of the tilt adjustment mechanism in FIG. 4;

FIG. 8 is a perspective view showing an assembly structure of the first structural member and pointer member in FIG. 7 from another angle;

FIG. 9 is an exploded and partially enlarged view of the tilt adjustment mechanism according to embodiments of the present disclosure;

FIG. 10 is a schematic structural view when the tilt angle between the second structural member and first structural member is 0 degrees according to embodiments of the present disclosure;

FIG. 11 is a schematic structural view when the tilt angle between the second structural member and first structural member is +5 degrees according to embodiments of the present disclosure;

FIG. 12 is a schematic structural view when the tilt angle between the second structural member and first structural member is −15 degrees according to embodiments of the present disclosure;

FIG. 13 is a perspective view of the tilt adjustment mechanism according to a second embodiment of the present disclosure;

FIG. 14 is an exploded view of FIG. 13;

FIG. 15 is a perspective view of FIG. 14 from another angle;

FIG. 16 is another perspective view of FIG. 14 from a different angle;

FIG. 17 is an exploded and partially enlarged view of the tilt adjustment mechanism in FIG. 13;

FIG. 18 is a perspective view of the mounting bracket when the tilt angle is 0 degree according to a second embodiment of the present disclosure;

FIG. 19 is a perspective view of the mounting bracket when the tilt angle is +5 degree according to the second embodiment of the present disclosure;

FIG. 20 is a perspective view of the mounting bracket when the tilt angle is −15 degree according to the second embodiment of the present disclosure;

FIG. 21 is an exploded view of an elastic support member in the tilt adjustment mechanism according to embodiments of the present disclosure;

FIG. 22 illustrates a range of tilt angles between the second structural member and first structural member;

FIG. 23 illustrates the second structural member tilted upward 5 degrees relative to the first structural member;

FIG. 24 illustrates the second structural member tilted downward 15 degrees relative to the first structural member;

FIG. 25 is an exploded view of a wall plate according to embodiments of the present disclosure;

FIG. 26 is a structural and installation view of a multimedia plate according to embodiments of the present disclosure;

FIG. 27 is a schematic view showing an interlocking connection between the multimedia plate and wall plate according to embodiments of the present disclosure;

FIG. 28 is a schematic view showing the interlocking connection between the multimedia plate and different edges of the wall plate according to embodiments of the present disclosure;

FIG. 29 is an exploded view of a support arm according to embodiments of the present disclosure;

FIG. 30 is an exploded view of the second structural member and horizontal adjustment mechanism according to embodiments of the present disclosure;

FIG. 31 is an exploded view of a panel according to embodiments of the present disclosure;

FIG. 32 is an exploded view of a mounting member according to embodiments of the present disclosure.

### DETAILED DESCRIPTION OF ILLUSTRATED EMBODIMENTS

Embodiments of the present disclosure are described in detail below. Examples of the embodiments are shown in the accompanying drawings. The same or similar labeling throughout denotes the same or similar elements or elements having the same or similar functions. The embodiments described below by reference to the accompanying drawings are exemplary and are intended to be configured to explain the present disclosure and are not to be construed as limiting the present disclosure.

Furthermore, the terms “first” and “second” are used for descriptive purposes only and are not to be understood as indicating or implying relative importance or implicitly specifying the number of technical features indicated. Therefore, a feature defined with “first” or “second” may include one or more such features, either explicitly or implicitly. In the description of the present disclosure, “more than one” means two or more, unless otherwise expressly and specifically limited.

In the present disclosure, unless otherwise expressly specified and limited, the terms “connected”, “fixed”, and so on are to be understood broadly, e.g., they may be fixedly connected, removably connected, or integrally connected; they may be mechanically connected or electrically connected; they may be directly connected or indirectly connected through an intermediate medium; they may be interconnected within two elements or an interactive relationship between two elements. For those of ordinary skill in the art, the specific meaning of the above terms in the present disclosure may be understood on a case-by-case basis.

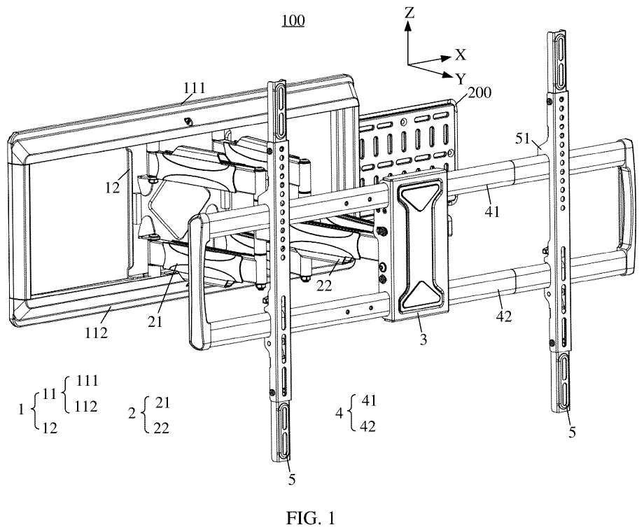

Please refer to FIG. 1, FIG. 1 is a perspective view of a mounting bracket for mounting a display device according to embodiments of the present disclosure. For ease of description, a front-rear direction of the mounting bracket 100 shown in FIG. 1 is defined as a Y-axis direction (i.e., the thickness direction), a left-right direction of the mounting bracket 100 shown in FIG. 1 is defined as a X-axis direction (i.e., the length direction), and a height direction of the mounting bracket 100 shown in FIG. 1 is defined as a Z-axis direction. The directional terms such as “top,” “bottom,” “left,” and “right” used in the description of the mounting bracket 100 in the embodiments of the present disclosure are based on the orientation shown in FIG. 1 of the specification drawings, where the positive Z-axis direction is “top,” the negative Z-axis direction is “bottom,” the negative X-axis direction is “left,” the positive X-axis direction is “right,” the negative Y-axis direction is “rear,” and the positive Y-axis direction is “front.” These terms do not limit the actual application scenarios of the mounting bracket 100. In this embodiment, the display device is a television. In other embodiments, the display device may also be a monitor or other device with a display screen, which is not limited herein.

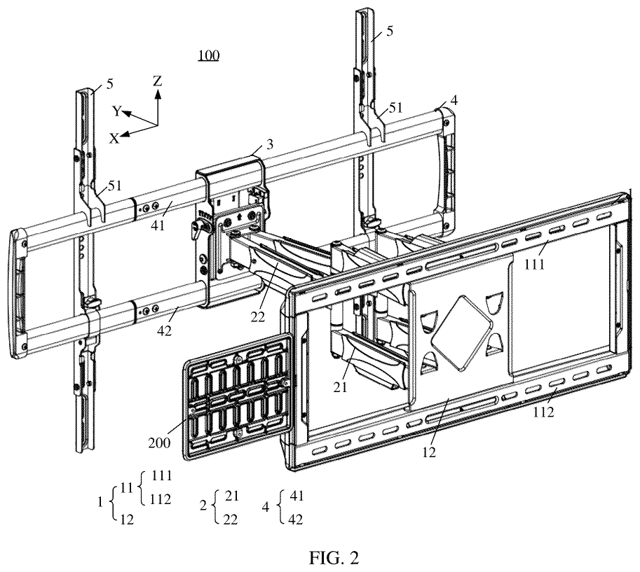

Please refer to FIGS. 1 and 2. FIG. 2 is a perspective view showing the mounting bracket for mounting the display device in another view according to embodiments of the present disclosure when the mounting bracket is in an unfolded state. The mounting bracket 100 can include a wall plate 1. The wall plate 1 is configured for mounting on a wall. The wall may include but is not limited to wood-stud gypsum board walls, reinforced concrete walls, brick-concrete structure walls, or cabinet panels mounted on walls. As shown in FIGS. 1 and 2, the wall plate 1 can include a rectangular frame 11 and a connecting plate 12. The rectangular frame 11 can include an upper wall plate 111 and a lower wall plate 112, which are arranged in parallel. The upper wall plate 111 and the lower wall plate 112 are respectively defined with a plurality of mounting holes (not shown in FIGS. 1 and 2). Mounting members pass through the mounting holes respectively and are nailed into the wall, thereby fixing the wall plate 1 to the wall. The connecting plate 12 is arranged within the rectangular frame 11 and connected between the upper wall plate 111 and the lower wall plate 112 of the rectangular frame 11. It can be understood that in other embodiments, the wall plate 1 may have other structures. For example, the wall plate 1 may also be a split-type wall plate, e.g., a dual-wall-plate structure, which is not limited herein.

The mounting bracket 100 can further include a support arm 2. One end of the support arm 2 is pivotally connected to the wall plate 1. As shown in FIGS. 1 and 2, the support arm 2 has a two-segment structure, specifically including at least one rear support arm 21 and a front support arm 22. End of the rear support arm 21 is pivotally connected to the connecting plate 12 of the wall plate 1, and the other end of the rear support arm 21 is pivotally connected to one end of the front support arm 22. The central axes of the pivot shafts of the rear support arm 21 and the front support arm 22 are both parallel to the height direction Z.

In this embodiment, the mounting bracket 100 can include two support arms 2. Each support arm 2 can include at least one rear support arm 21 and a front support arm 22. The rear support arms 21 of the two support arms 2 are respectively pivotally connected to different positions of the connecting plate 12 in the left-right direction (X-axis direction). In other embodiments, the support arm 2 may be a single arm, which is not limited herein.

In this embodiment, each support arm 2 can include two rear support arms 21 and one front support arm 22. Ends of the two rear support arms 21 of each support arm 2 are pivotally connected to different positions of the connecting plate 12 in the height direction (Z-axis direction), and the other ends of the two rear support arms 21 of each support arm 2 are respectively pivotally connected to two opposite sides of one end of the front support arm 22 in the height direction. In other embodiments, each support arm 2 may include one rear support arm 21 and one front support arm 22. Therefore, the present disclosure does not limit the number of rear support arms 21 and front support arms 22.

The mounting bracket 100 can further include a tilt adjustment mechanism 3, a panel 4, and at least one mounting member 5. The tilt adjustment mechanism 3 is connected between the other end of the support arm 2 and the panel 4. The mounting member 5 is configured for fixedly connecting to the back of the display device and hanging on the panel 4.

When the mounting bracket 100 includes the two support arms 2, the other ends of the two support arms 2 are respectively connected to the tilt adjustment mechanism 3.

When each support arm 2 includes two rear support arms 21 and one front support arm 22, the other ends of the front support arms 22 of the two support arms 2 are respectively connected to the tilt adjustment mechanism 3.

As shown in FIGS. 1 and 2, the panel 4 is approximately rectangular and can include an upper horizontal bar 41 and a lower horizontal bar 42. The upper horizontal bar 41 and the lower horizontal bar 42 are arranged in parallel.

The mounting member 5 can include a hook 51. The hook 51 is hung on the upper horizontal bar 41.

The mounting member 5 is also locked to the lower horizontal bar 42.

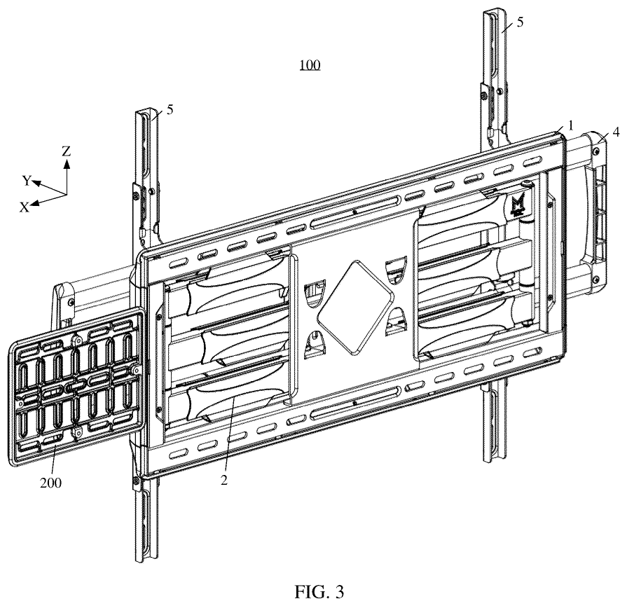

Please refer to FIGS. 2 and 3 together. As shown in FIG. 2, the mounting bracket 100 is in an unfolded state. As shown in FIG. 3, the mounting bracket 100 is in a folded state. It can be seen from FIG. 3 that when the mounting bracket 100 is in the folded state, the rear support arm 21 and the front support arm 22 are completely abutted against with each other, thereby reducing the thickness of the mounting bracket 100 in the front-rear direction when the mounting bracket 100 is in the folded state.

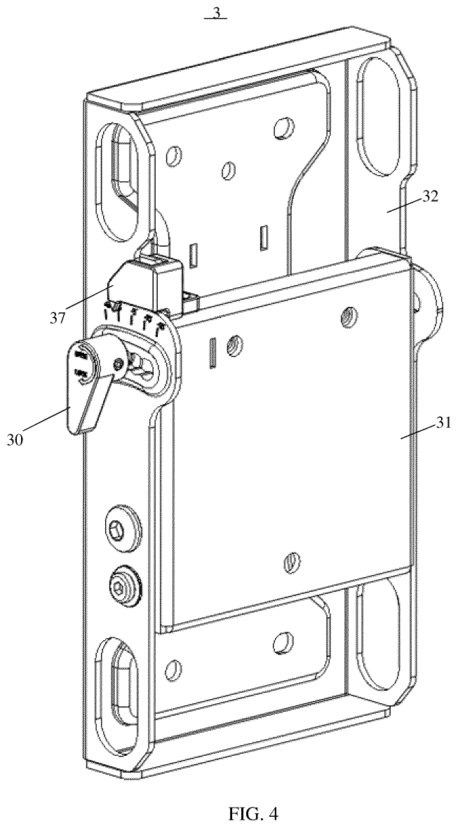

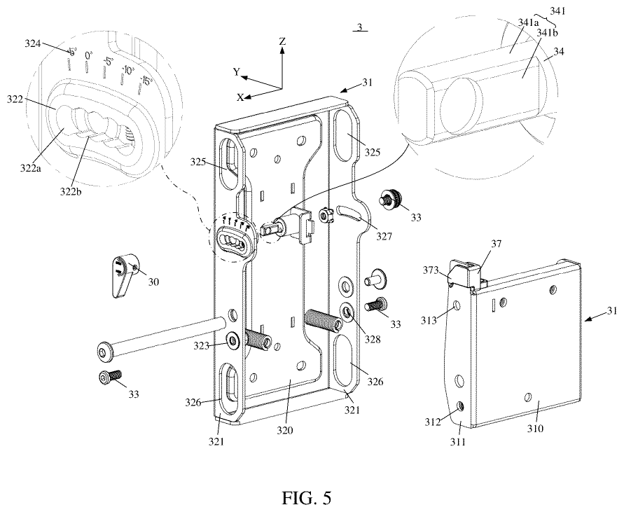

Please refer to FIGS. 4 and 5. FIG. 4 is a perspective view of a tilt adjustment mechanism according to a first embodiment of the present disclosure. FIG. 5 is an exploded view of FIG. 4. As shown in FIGS. 4 and 5, the tilt adjustment mechanism 3 can include a first structural member 31 and a second structural member 32. A first sidewall 311 of the first structural member 31 defines a first connection hole 312 and a second connection hole 313. A second sidewall 321 of the second structural member 32 defines a first pivot hole 323 and an adjustment hole 322. The adjustment hole 322 can include at least two adjustment sub-holes 322a arranged along the front-rear direction of the tilt adjustment mechanism 3. The distance between the centers of two adjacent adjustment sub-holes 322a is smaller than the diameter of the adjustment sub-holes 322a. Different adjustment sub-holes 322a correspond to different tilt angles. The tilt adjustment mechanism 3 can further include a connecting member 33 and an adjustment rod 34. The connecting member 33 is connected between the first connection hole 312 and the first pivot hole 323. The adjustment rod 34 is penetrated between the adjustment hole 322 and the second connection hole 313. The adjustment rod 34 can include a flattened portion 341. The flattened portion 341 can include a cylindrical surface 341a and two planes 341b located on opposite sides of the cylindrical surface 341a. The diameter of the cylindrical surface 341a is equal to the diameter of the adjustment sub-holes 322a. The distance between the two planes 341b is less than or equal to the width of the connecting portion between two adjacent adjustment sub-holes 322a. When the adjustment rod 34 is rotated to a first position, the adjustment rod 34 can pass through the connecting portion between two adjacent adjustment sub-holes 322a. When the adjustment rod 34 is rotated to a second position, the adjustment rod 34 is locked relative to the adjustment hole 322.

Therefore, in the present disclosure, the first position refers to a position where the two planes 341b of the flattened portion 341 of the adjustment rod 34 are approximately oriented toward the arc surfaces of the adjustment sub-holes 322a. Therefore, when the adjustment rod 34 is rotated to the first position, the flattened portion 341 of the adjustment rod 34 can pass through the connecting portion between two adjacent adjustment sub-holes 322a, allowing the adjustment rod 34 to slide along the front-rear direction of the tilt adjustment mechanism 3 within the adjustment hole 322 to adjust the tilt angle of the second structural member 32 relative to the first structural member 31 (the angle of rotation about the X-axis). The second position refers to a position where the two planes 341b of the flattened portion 341 of the adjustment rod 34 are approximately oriented toward the connecting portion between two adjacent adjustment sub-holes 322a. Therefore, when the adjustment rod 34 is rotated to the second position, the cylindrical surface 341a of the flattened portion 341 of the adjustment rod 34 fits with the arc surfaces of the adjustment sub-holes 322a, and the planes 341b of the flattened portion 341 of the adjustment rod 34 face the connecting portion between two adjacent adjustment sub-holes 322a, preventing the adjustment rod 34 from passing through the connecting portion between two adjacent adjustment sub-holes 322a. Thus, the adjustment rod 34 is locked relative to the adjustment hole 322. As a result, the mounting bracket 100 of the present disclosure can achieve stepwise adjustment of the tilt angle, is easy to lock, and ensures that the tilt angle of the mounting bracket 100 does not change under the gravitational force of the display device after adjustment, improving the locking reliability of the tilt angle after adjustment.

In at least one embodiment, the front-rear direction of the tilt adjustment mechanism 3 is approximately parallel to the Y-axis direction of the mounting bracket 100.

In at least one embodiment, the diameters of at least two adjustment sub-holes 322a are the same, and the width of the connecting portion between two adjacent adjustment sub-holes 322a is smaller than the diameter of the adjustment sub-holes 322a.

In at least one embodiment, the first connection hole 312 and the second connection hole 313 are arranged along the height direction of the mounting bracket 100 on the first sidewall 311 of the first structural member 31. The first connection hole 312 is located below the second connection hole 313.

In at least one embodiment, the first pivot hole 323 and the adjustment hole 322 are arranged along the height direction of the mounting bracket 100 on the second sidewall 321 of the second structural member 32. The first pivot hole 323 is located below the adjustment hole 322.

In at least one embodiment, the tilt angle refers to the angle of rotation of the panel 4 relative to the wall plate 1 about the X-axis direction.

In at least one embodiment, as shown in FIGS. 4 and 5, the at least two adjustment sub-holes 322a include five adjustment sub-holes 322a, which correspond to −15 degrees, −10 degrees, −5 degrees, 0 degrees, and +5 degrees from front to back. It can be understood that in other embodiments, the number of adjustment sub-holes 322a and the corresponding tilt adjustment angles can be adjusted according to actual needs, which is not limited herein.

In at least one embodiment, the first structural member 31 is a large square plate, and the second structural member 32 is a connecting plate. The first structural member 31 can include a first plate body 310 and two first sidewalls 311 connected to opposite sides of the first plate body 310. The second structural member 32 can include a second plate body 320 and two second sidewalls 321 connected to opposite sides of the second plate body 320. The opening of the first structural member 31 and the opening of the second structural member 32 face each other, and the two first sidewalls 311 of the first structural member 31 is embedded between the two second sidewalls 321 of the second structural member 32, which reduces the thickness dimension of the tilt adjustment mechanism 3 in the Y-axis direction of the mounting bracket 100.

In at least one embodiment, the top and bottom ends of the second sidewall 321 respectively define a first through hole 325 and a second through hole 326. The upper horizontal bar 41 of the panel 4 penetrates through the first through hole 325, and the lower horizontal bar 42 of the panel 4 penetrates through the second through hole 326. Moreover, the second structural member 32 can slide along the X-axis direction of the mounting bracket 100 on the upper horizontal bar 41 and the lower horizontal bar 42, thereby adjusting the horizontal position of the display device relative to the mounting bracket 100.

In at least one embodiment, the adjustment hole 322 is defined on one of the second sidewalls 321. The adjustment hole 322 has a curvature and is an arc-shaped elongated hole centered on the first pivot hole 323, located between the first through hole 325 and the second through hole 326. The other second sidewall 321 is defined with a first arc-shaped hole 327 at a position corresponding to the adjustment hole 322 and a circular hole 328 at a position corresponding to the first pivot hole 323. Correspondingly, the first sidewall 311 is defined with a third connection hole (not shown) and a fourth connection hole (not shown) along the height direction (Z-axis direction). One connecting member 33 is connected between the circular hole 328 and the third connection hole, and another connecting member 33 is connected between the first arc-shaped hole 327 and the fourth connection hole.

Therefore, the adjustment hole 322 has a curvature and is an arc-shaped elongated hole centered on the first pivot hole 323, making the sliding between the adjustment hole 322 and the adjustment rod 34 smoother during tilt angle adjustment.

It can be understood that the connecting member 33 is a combination structure of a screw and a nut, allowing locking when needed. When adjusting the tilt angle, the nut can be loosened, the tilt angle adjusted, and then locked again.

In at least one embodiment, both second sidewalls 321 may be defined with the adjustment hole 322 and the first pivot hole 323, which is not limited herein.

In at least one embodiment, as shown in FIG. 5, since the adjustment hole 322 and the first arc-shaped hole 327 are elongated, they need to meet a preset length in the front-rear direction (Y-axis direction) of the mounting bracket 100. Therefore, the position of the first sidewall 311 corresponding to the adjustment hole 322 protrudes backward in the front-rear direction of the mounting bracket 100 compared to other positions, and the position of the second sidewall 321 corresponding to the first arc-shaped hole 327 protrudes backward in the front-rear direction of the mounting bracket 100 compared to other positions.

Therefore, the locally protruding structure allows other areas of the second sidewall 321 of the second structural member 32 to have smaller dimensions in the front-rear direction of the mounting bracket 100, making the second structural member 32 more compact.

In at least one embodiment, please refer to FIG. 5 again. The arc extensions of two adjacent adjustment sub-holes 322a intersect to form a protrusion 322b, i.e., a protrusion 322b is formed between every two adjacent adjustment sub-holes 322a. When the adjustment rod 34 is engaged with one of the adjustment sub-holes 322a and the adjustment rod 34 is rotated to the second position, the protrusion 322b can block the sliding of the adjustment rod 34 along the length direction of the adjustment hole 322, thereby achieving reliable locking. The length direction of the adjustment hole 322 is approximately parallel to the Y-axis direction of the mounting bracket 100.

In at least one embodiment, the tilt adjustment mechanism 3 can further include a rotating handle 30. The rotating handle 30 is located on an outer surface of the second sidewall 321 of the second structural member 32 where the adjustment hole 322 is defined and is non-rotatably connected to the flattened portion 341 of the adjustment rod 34. The rotating handle 30 drives the adjustment rod 34 to rotate between the first position and the second position.

Therefore, the rotating handle 30 makes it more convenient for the operator to rotate the adjustment rod 34 and saves effort. It can be understood that in other embodiments, a key adapted to the flattened portion 341 of the adjustment rod 34 may be used to rotate the adjustment rod 34. Therefore, the rotating handle 30 may be omitted.

In at least one embodiment, when the adjustment rod 34 is rotated to the first position, the two planes 341b of the flattened portion 341 of the adjustment rod 34 are approximately oriented toward the arc surfaces of the adjustment sub-holes 322a. When the adjustment rod 34 is rotated to the second position, the two planes 341b of the flattened portion 341 of the adjustment rod 34 are approximately oriented toward the connecting portion between two adjacent adjustment sub-holes 322a. Therefore, the rotation angle range of the rotating handle 30 is 0 to 90 degrees.

Therefore, compared to the prior art where the rotating handle needs to be rotated several turns to achieve locking, in the present disclosure, the rotating handle 30 only needs to be rotated 90 degrees to achieve locking, making the operation simpler and more convenient.

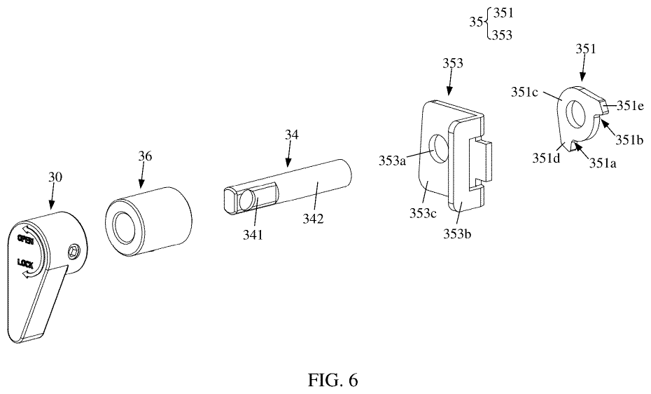

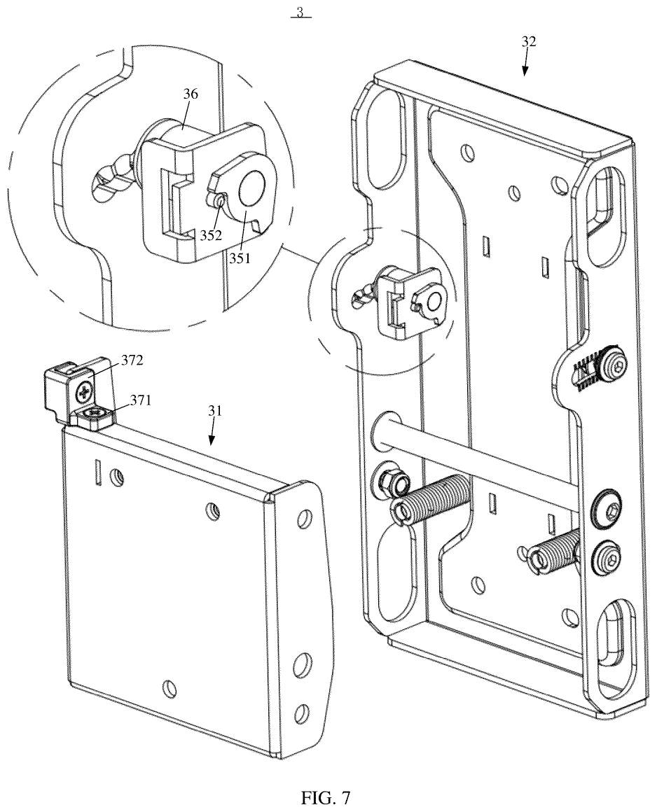

In at least one embodiment, please refer to FIGS. 6 and 7 together. FIG. 6 is a further exploded view of partial components of the tilt adjustment mechanism according to embodiments of the present disclosure. FIG. 7 is an exploded and partially enlarged view of the tilt adjustment mechanism in FIG. 4. The adjustment rod 34 can further include a round rod portion 342 connected to the flattened portion 341. The tilt adjustment mechanism 3 can further include a rotation limiting member 35. The rotation limiting member 35 can include a rotating member 351 and a limiting post 352. The rotating member 351 is connected to the round rod portion 342. The limiting post 352 is fixed on a surface of the first structural member 31 facing the second structural member 32. The cooperation between the rotating member 351 and the limiting post 352 limits the rotation angle of the adjustment rod 34 relative to the second structural member 32.

Therefore, since the limiting post 352 of the rotation limiting member 35 is fixed on the first structural member 31, and the first structural member 31 has no degree of freedom in the rotation direction about the X-axis (tilt), the rotation angle range of the rotating member 351 can be limited by the limiting post 352, thereby limiting the rotation angle range of the adjustment rod 34 and preventing excessive rotation of the adjustment rod 34, which could affect operation.

In at least one embodiment, please refer to FIGS. 6 and 7 again. The rotation limiting member 35 can further include a fixing member 353. The fixing member 353 is fixed on the surface of the first structural member 31 facing the second structural member 32. The fixing member 353 defines a through hole 353a along the length direction of the adjustment rod 34. The round rod portion 342 is penetrated into the through hole 353a. The limiting post 352 is located on the surface of the fixing member 353. The rotating member 351 can include a first limiting portion 351a and a second limiting portion 351b. When the limiting post 352 is engaged with the first limiting portion 351a, the adjustment rod 34 is rotated to the first position, the adjustment rod 34 can pass through the connecting portion between two adjacent adjustment sub-holes 322a. When the limiting post 352 is engaged with the second limiting portion 351b, the adjustment rod 34 is rotated to the second position, the adjustment rod 34 is locked relative to the adjustment hole 322.

Therefore, the present disclosure adopts the method of disposing the limiting post 352 on the fixing member 353. The adaptation relationship between the limiting post 352 and the rotating member 351 can be more stable and reliable. It should be understood that in other embodiments, the limiting post 352 may extend to the surface of the first structural member 31 and be fixed on the surface of the first structural member 31, which is not limited herein.

In this embodiment, the fixing member 353 is approximately L-shaped. The fixing member 353 can include a first plate portion 353b and a second plate portion 353c, which are approximately perpendicular to each other. The first plate portion 353b is fixed on the first plate body 310 of the first structural member 31. The second plate portion 353c is approximately parallel to the second sidewall 321. The second plate portion 353c defines the through hole 353a along the length direction of the adjustment rod 34. The limiting post 352 is located on the surface of the second plate portion 353c facing away from the second sidewall 321 where the adjustment hole 322 is defined. The limiting post 352 is a columnar body protruding from the surface of the second plate portion 353c facing away from the second sidewall 321 where the adjustment hole 322 is defined. It can be understood that the limiting post 352 is located on a rotation path of the rotating member 351, thereby limiting the rotation angle of the rotating member 351.

In at least one embodiment, please refer to FIG. 6 again. The rotating member 351 can include a ring portion 351c, a first protruding portion 351d, and a second protruding portion 351e. The first protruding portion 351d and the second protruding portion 351e extend radially outward from two different positions of the ring portion 351c. The first protruding portion 351d and the ring portion 351c cooperatively form the first limiting portion 351a. The second protruding portion 351e and the ring portion 351c cooperatively form the second limiting portion 351b. Therefore, the first limiting portion 351a and the second limiting portion 351b are approximately V-shaped, and the V-shaped openings of the first limiting portion 351a and the second limiting portion 351b face each other. The arc between the V-shaped openings of the first limiting portion 351a and the second limiting portion 351b is a rotation stroke of the rotating member 351. Therefore, the rotation stroke of the rotating member 351 can be adjusted by adjusting the arc length between the first limiting portion 351a and the second limiting portion 351b. In this embodiment, the rotation stroke of the rotating member 351 is 90 degrees.

In at least one embodiment, please refer to FIGS. 6 and 7 again. The tilt adjustment mechanism 3 can further include an abutting member 36. The abutting member 36 is sleeved on the round rod portion 342. The two opposite ends of the abutting member 36 respectively abut between the second sidewall 321 of the second structural member 32 and the fixing member 353.

In this embodiment, the abutting member 36 is columnar and defines a through hole in the middle. The round rod portion 342 is inserted into the through hole of the abutting member 36.

It can be understood that in other embodiments, the shape of the abutting member 36 is not limited to cylindrical and may also be prismatic, square, or other shapes, which is not limited herein.

Therefore, the abutting member 36 provides support for the fixing member 353, making the installation of the fixing member 353 more stable and reliable.

In at least one embodiment, please refer to FIG. 5 again. The outer surface of the second sidewall 321 where the adjustment hole 322 is defined is provided with a scale marking 324 at positions corresponding to the adjustment hole 322. The scale marking 324 is configured to indicate the tilt angle, such as −15 degrees, −10 degrees, −5 degrees, 0 degrees, and +5 degrees. The tilt adjustment mechanism 3 can further include a pointer member 37. The pointer member 37 is connected between the first structural member 31 and the second structural member 32. When the first structural member 31 has different tilt angles relative to the second structural member 32, the pointer member 37 cooperates with the scale marking 324 to indicate the tilt angle of the second structural member 32 relative to the first structural member 31.

Therefore, since the adjustment hole 322 in the present disclosure is a stepwise adjustment hole, the adjustment rod 34 needs to engage with any one of the adjustment sub-holes 322a of the adjustment hole 322 to limit the tilt angle of the second structural member 32 relative to the first structural member 31. Moreover, only when the center of the flattened portion 341 of the adjustment rod 34 coincides with the center of any one of the adjustment sub-holes 322a of the adjustment hole 322, the adjustment rod 34 can be rotated so that the cylindrical surface 341a of the flattened portion 341 fits with the arc surface of the adjustment sub-hole 322a, and the planes 341b of the flattened portion 341 face the connecting portion between two adjacent adjustment sub-holes 322a, preventing the adjustment rod 34 from passing through the connecting portion between two adjacent adjustment sub-holes 322a and locking the adjustment rod 34 relative to the adjustment hole 322. Therefore, if the center of the flattened portion 341 of the adjustment rod 34 does not coincide with the center of any one of the adjustment sub-holes 322a of the adjustment hole 322, the adjustment rod 34 cannot be rotated by the rotating handle 30 due to interference from the protrusion 322b between two adjacent adjustment sub-holes 322a. Thus, by using the pointer member 37 to indicate the tilt angle of the second structural member 32 relative to the first structural member 31, it can be determined whether the center of the flattened portion 341 of the adjustment rod 34 coincides with the center of any one of the adjustment sub-holes 322a of the adjustment hole 322 based on the scale indicated by the pointer member 37. For example, the five adjustment sub-holes 322a correspond to scales of −15 degrees, −10 degrees, −5 degrees, 0 degrees, and +5 degrees, respectively. When the scale indicated by the pointer member 37 is exactly 0 degrees, it can be determined that the center of the flattened portion 341 of the adjustment rod 34 coincides with the center of the 0-degree adjustment sub-hole 322a of the adjustment hole 322.

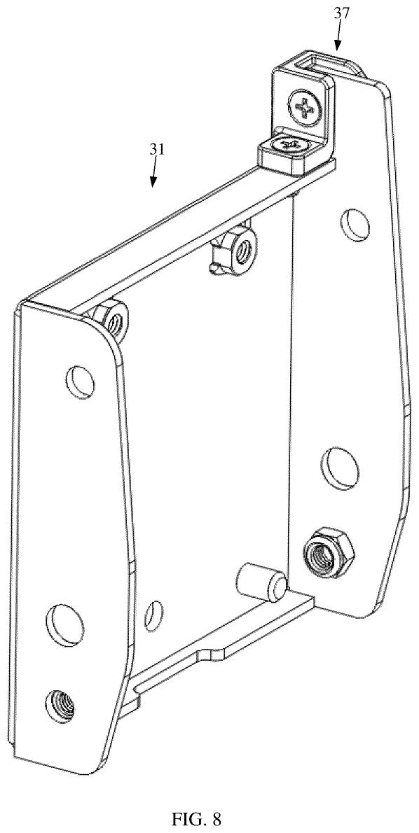

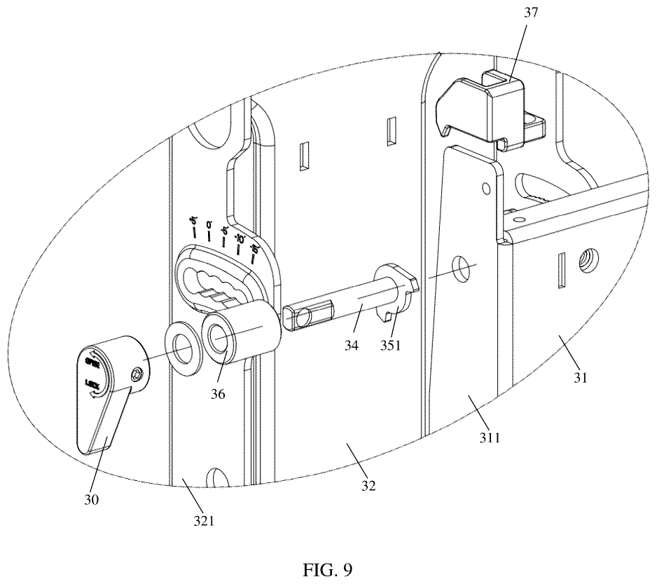

Please refer to FIGS. 5, 7, 8, and 9. In the first embodiment, the pointer member 37 is a structural member fixedly connected to the first structural member 31 and spanned across the second sidewall 321 of the second structural member 32 where the adjustment hole 322 is defined. Specifically, the pointer member 37 can include a connection portion 371, a spanning portion 372, and an indicator arrow 373. The connection portion 371 is connected to the first structural member 31. The spanning portion 372 is connected between the connection portion 371 and the indicator arrow 373. The spanning portion 372 is spanned across the first sidewall 311 of the first structural member 31 and the second sidewall 321 of the second structural member 32 where the adjustment hole 322 is defined. The indicator arrow 373 is located on the second sidewall 321 of the second structural member 32 where the adjustment hole 322 is defined and points to the scale marking 324.

Therefore, in the present disclosure, by configuring the structure of the pointer member 37, the pointer member 37 can be fixed to the first structural member 31 and spanned across the first sidewall 311 of the first structural member 31 and the second sidewall 321 of the second structural member 32 where the adjustment hole 322 is provided, and can point to the scale marking 324 on the outer surface of the second sidewall 321 where the adjustment hole 322 is provided. The structure is simple and reliable.

In at least one embodiment, the spanning portion 372 is U-shaped. The connection portion 371 is perpendicularly connected to one arm of the spanning portion 372. The connection portion 371 is connected to the top surface of the second structural member 32. Specifically, the top end of the first plate body 310 of the first structural member 31 has a planar flange. The first sidewall 311 of the first structural member 31 for setting the pointer member 37 extends a preset length in the height direction relative to the flange. Therefore, the spanning portion 372 of the pointer member 37 can be spanned from the rear of the first sidewall 311 across the portion of the first sidewall 311 extending relative to the flange. The connection portion 371 of the pointer member 37 is bent and extends from one arm of the spanning portion 372 toward the surface of the flange and is fixed to the flange. The arm of the spanning portion 372 is fixed to the first sidewall 311 of the first structural member 31. The width between the two arms of the spanning portion 372 is greater than or equal to the sum of the thicknesses of the first sidewall 311 and the second sidewall 321. Therefore, the second sidewall 321 can also be inserted into the U-shaped space of the spanning portion 372, allowing the indicator arrow 373 to point to the scale marking 324 on the outer surface of the second sidewall 321 where the adjustment hole 322 is provided.

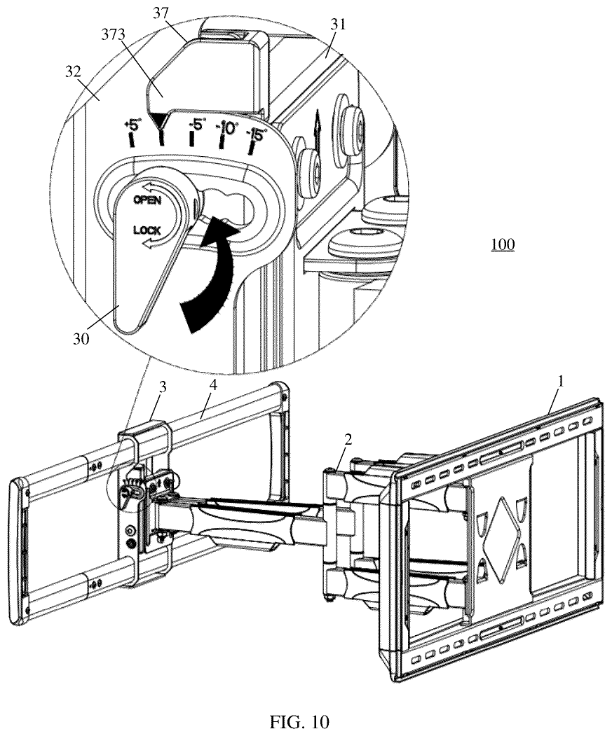

Please refer to FIG. 10. FIG. 10 is a schematic structural view when the tilt angle between the second structural member 32 and first structural member 31 is 0 degrees according to embodiments of the present disclosure. As shown in FIG. 10, the indicator arrow 373 of the pointer member 37 points exactly to 0 degrees. The rotating handle 30 can be rotated from 0 degrees to 90 degrees to achieve locking.

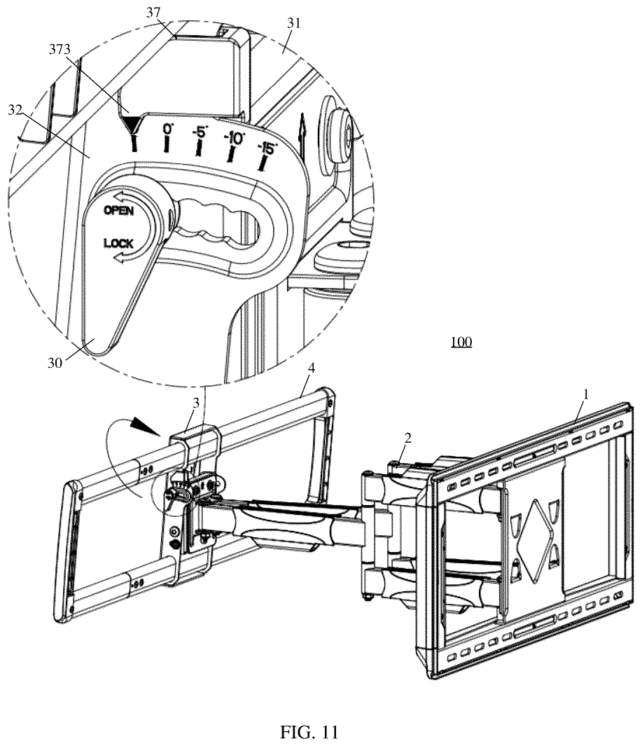

Please refer to FIG. 11. FIG. 11 is a schematic structural view when the tilt angle between the second structural member 32 and first structural member 31 is +5 degrees according to embodiments of the present disclosure. As shown in FIG. 11, the indicator arrow 373 of the pointer member 37 points exactly to +5 degrees. The rotating handle 30 can be rotated from 0 degrees to 90 degrees to achieve locking.

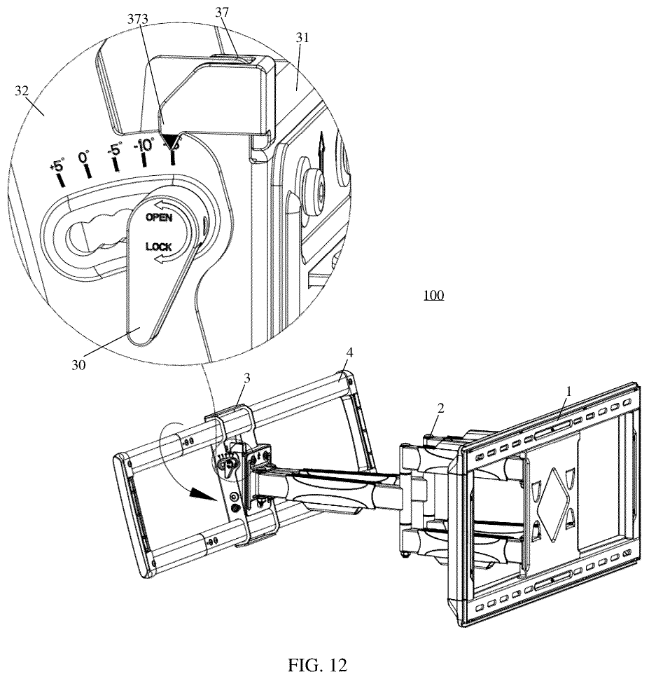

Please refer to FIG. 12. FIG. 12 is a schematic structural view when the tilt angle between the second structural member 32 and first structural member 31 is −15 degrees according to embodiments of the present disclosure. As shown in FIG. 12, the indicator arrow 373 of the pointer member 37 points exactly to −15 degrees. The rotating handle 30 can be rotated from 0 degrees to 90 degrees to achieve locking.

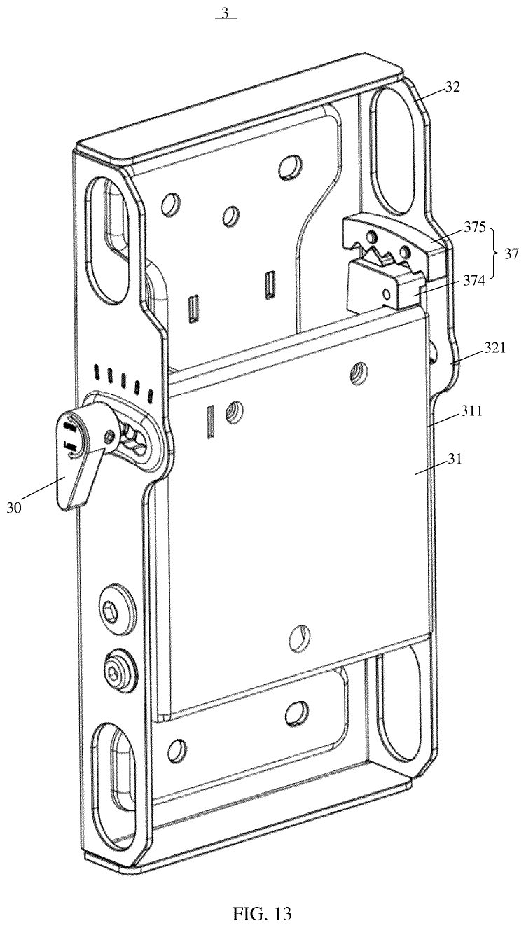

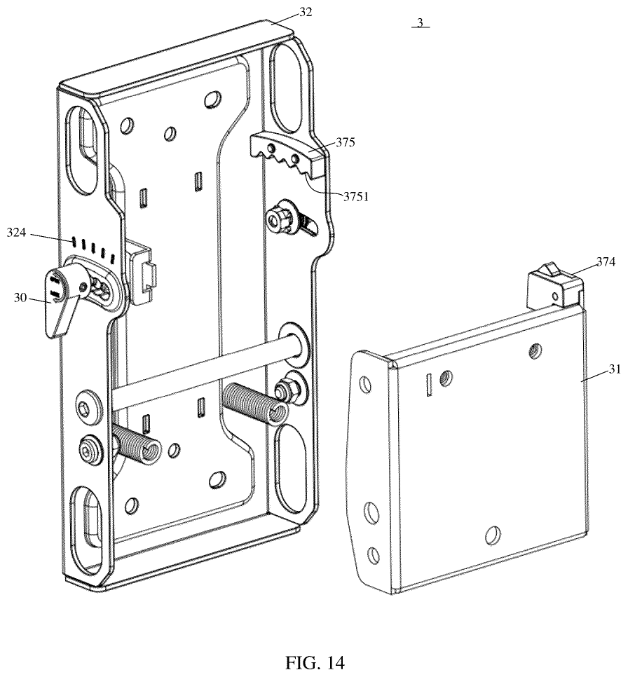

Please refer to FIGS. 13 and 14. FIG. 13 is a perspective view of the tilt adjustment mechanism 3 according to a second embodiment of the present disclosure. FIG. 14 is an exploded view of FIG. 13. As shown in FIGS. 13 and 14, in the second embodiment, the pointer member 37 is a ratchet mechanism. The pointer member 37 can include a spring-loaded pin assembly 374 and an engagement member 375. The engagement member 375 is fixed to the second sidewall 321 of the second structural member 32. The engagement member 375 can include at least two engagement teeth 3751. Different engagement teeth 3751 correspond to different tilt angles respectively. The spring-loaded pin assembly 374 is fixed to the first sidewall 311 of the first structural member 31. When the second structural member 32 has different tilt angles relative to the first structural member 31, the spring-loaded pin assembly 374 engages with the corresponding engagement teeth 3751 to indicate the tilt angle of the second structural member 32 relative to the first structural member 31.

Therefore, by the relative position of the rotating handle 30 in the adjustment hole 322 and the scale marking 324 near the adjustment hole 322, the approximate tilt angle between the first structural member 31 and the second structural member 32 can be determined. Combined with the “click” sound when the spring-loaded pin assembly 374 and the corresponding engagement teeth 3751 of the engagement member 375 are engaged, the current tilt angle between the first structural member 31 and the second structural member 32 can be accurately determined. For example, if the expected tilt angle between the first structural member 31 and the second structural member 32 is +5 degrees, when it is determined based on the relative position of the rotating handle 30 in the adjustment hole 322 and the scale marking 324 near the adjustment hole 322 that the current tilt angle between the first structural member 31 and the second structural member 32 is close to the expected angle, combined with the “click” sound when the spring-loaded pin assembly 374 engages with the corresponding engagement teeth 3751, if the “click” sound is heard, it can be determined that the tilt angle between the first structural member 31 and the second structural member 32 has reached the expected angle, and the rotating handle 30 can be rotated to achieve locking.

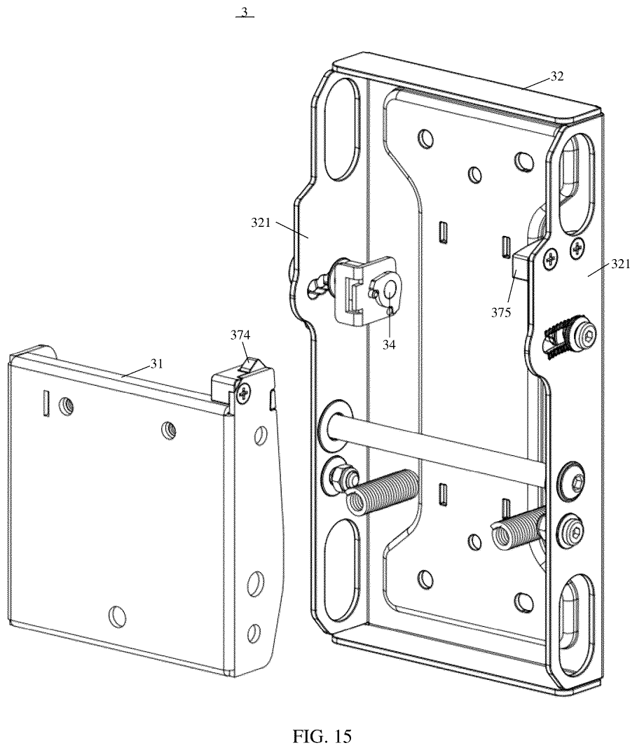

In at least one embodiment, please refer to FIG. 15. The adjustment rod 34 is disposed on one of the second sidewalls 321, and the engagement member 375 of the pointer member 37 is disposed on the other second sidewall 321. This avoids movement interference between the adjustment rod 34 and the pointer member 37.

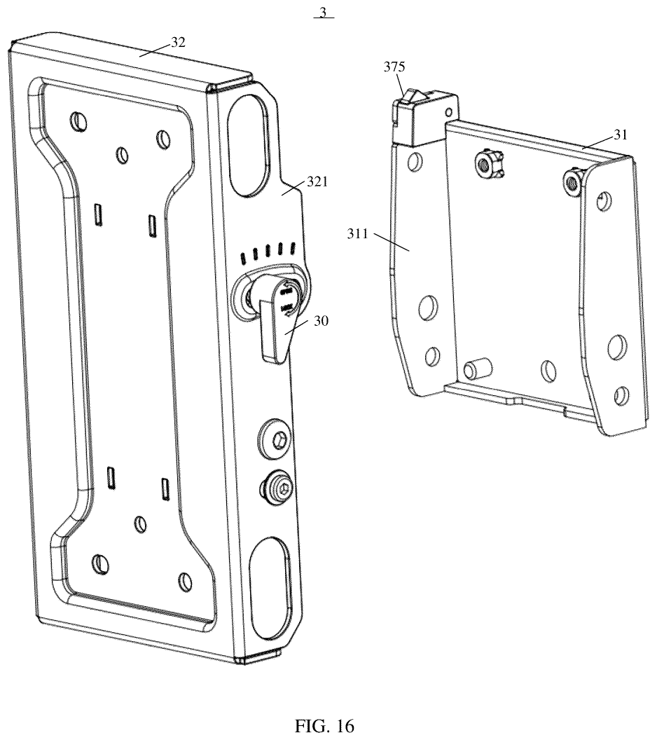

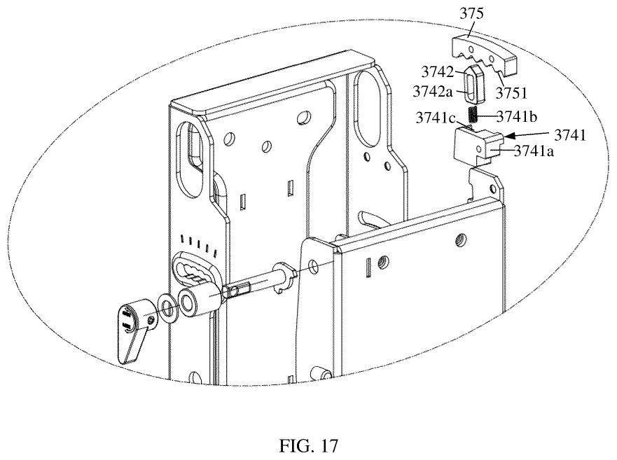

In at least one embodiment, please refer to FIGS. 16 and 17. The spring-loaded pin assembly 374 can include an elastic abutment member 3741 and a pin 3742. One end of the elastic abutment member 3741 is fixed to the first sidewall 311 of the first structural member 31. The other end of the elastic abutment member 3741 is connected to one end of the pin 3742. The other end of the pin 3742 facing the engagement teeth 3751 can engage with the engagement teeth 3751.

Therefore, the internal space of the first structural member 31 can be used to arrange the spring-loaded pin assembly 374, reducing the size of the mounting bracket 100 in the thickness direction.

In at least one embodiment, the engagement teeth 3751 and the end of the pin 3742 facing the engagement teeth 3751 are both sharp-angled.

Therefore, each engagement tooth 3751 can include two intersecting inclined surfaces. The two intersecting inclined surfaces serve as wedge surfaces, guiding the pin 3742 to move out of the engagement space of one engagement tooth 3751 and into the engagement space of another engagement tooth 3751. The sharp-angled end of the pin 3742 facing the engagement teeth 3751 better fits the shape of the engagement teeth 3751.

In at least one embodiment, the elastic abutment member 3741 can include a spring seat 3741a and a first spring 3741b. The spring seat 3741a is fixed to an inner surface of the first sidewall 311 of the first structural member 31. The spring seat 3741a defines a receiving groove 3741c and an abutment post in the receiving groove 3741c on a side facing the inner surface of the first sidewall 311 of the first structural member 31. The pin 3742 defines an elongated hole 3742a extending along the height direction of the tilt adjustment mechanism 3. The abutment post is inserted into the elongated hole 3742a. The first spring 3741b is also located in the elongated hole 3742a and abuts between the abutment post and the top end of the elongated hole 3742a.

Therefore, the spring seat 3741a and the first spring 3741b provide elastic force for the pin 3742 to move out of and into the engagement space of another engagement tooth 3751, ensuring a stable and reliable structure.

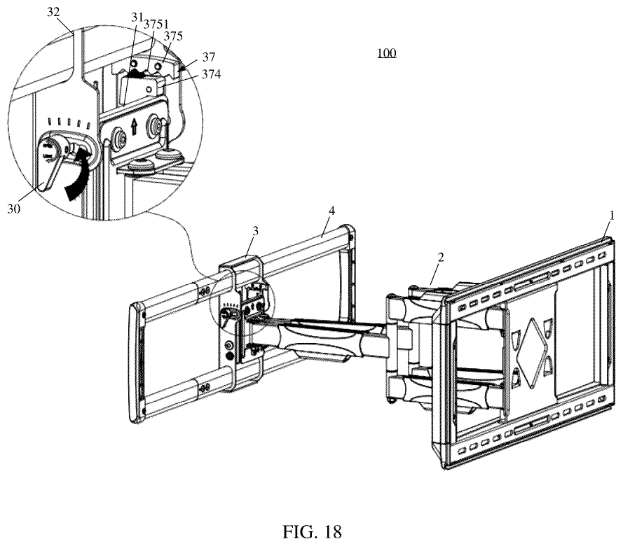

Please refer to FIG. 18. FIG. 18 is a perspective view of the mounting bracket 100 when the tilt angle is 0 degree according to a second embodiment of the present disclosure. As shown in FIG. 18, when the tilt angle between the first structural member 31 and the second structural member 32 is 0 degrees, the pin 3742 is exactly engaged with the engagement tooth 3751 of the engagement member 375 corresponding to 0 degrees.

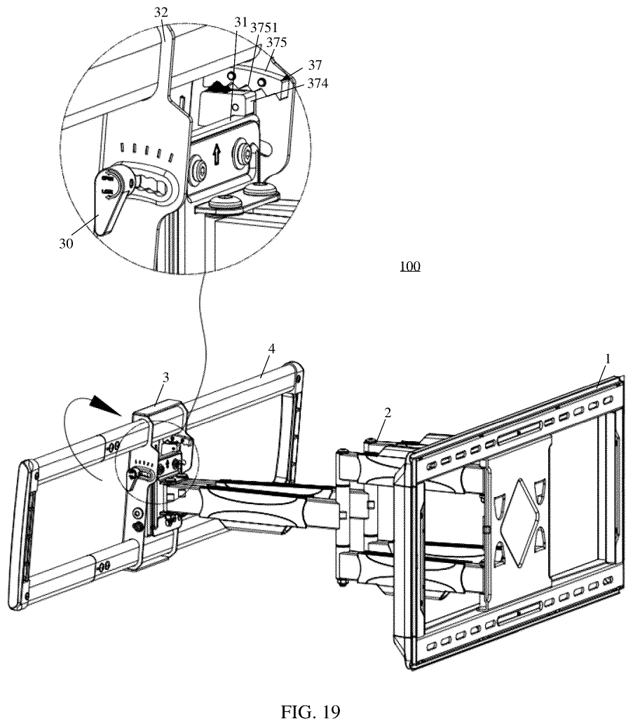

Please refer to FIG. 19. FIG. 19 is a perspective view of the mounting bracket 100 when the tilt angle is +5 degree according to the second embodiment of the present disclosure. As shown in FIG. 19, when the tilt angle between the first structural member 31 and the second structural member 32 is +5 degrees, the pin 3742 is exactly engaged with the engagement tooth 3751 of the engagement member 375 corresponding to +5 degrees.

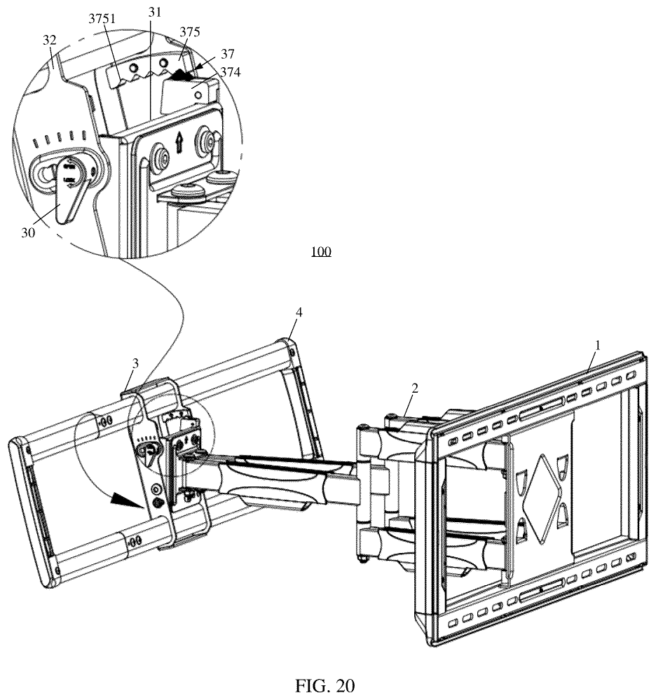

Please refer to FIG. 20. FIG. 20 is a perspective view of the mounting bracket 100 when the tilt angle is −15 degree according to the second embodiment of the present disclosure. As shown in FIG. 20, when the tilt angle between the first structural member 31 and the second structural member 32 is −15 degrees, the pin 3742 is exactly engaged with the engagement tooth 3751 of the engagement member 375 corresponding to −15 degrees.

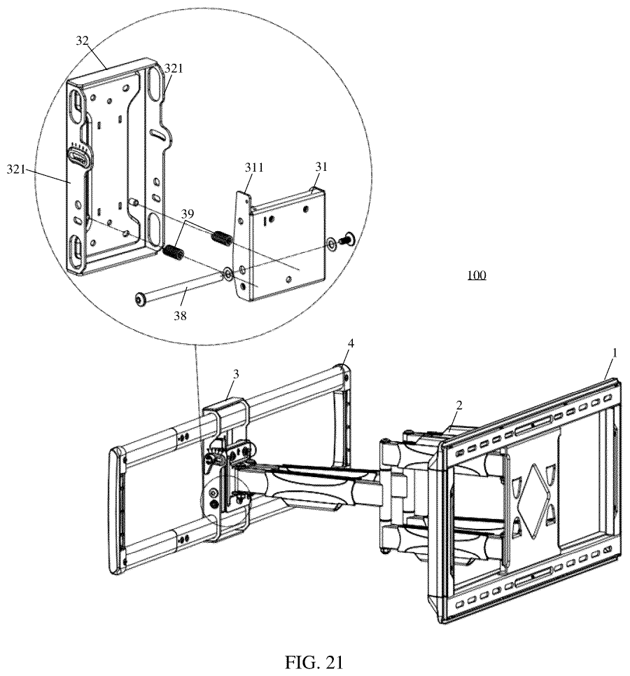

In at least one embodiment, please refer to FIGS. 15 and 21. The opening of the first structural member 31 and the opening of the second structural member 32 face each other, and the two first sidewalls 311 of the first structural member 31 is embedded between the two second sidewalls 321 of the second structural member 32. The tilt adjustment mechanism 3 can further include a pivot shaft 38 pivotally connected between the first sidewall 311 of the first structural member 31 and the second sidewall 321 of the second structural member 32. The tilt adjustment mechanism 3 can include at least one elastic support member 39 located between the first structural member 31 and the second structural member 32. The elastic support member 39 and the adjustment rod 34 are located on opposite sides of the pivot shaft 38. The elastic restoring force of the elastic support member 39 is configured to offset at least part of the gravity of the display device.

Therefore, the pivot shaft 38 serves as a fulcrum for the relative rotation between the first structural member 31 and the second structural member 32. The elastic support member 39 is located below the pivot shaft 38 in the height direction. When the top end of the second structural member 32 is subjected to the gravitational force of the display device and tends to tilt downward about the pivot shaft 38, the elastic support member 39 abuts between the first structural member 31 and the second structural member 32, offsetting the gravity of the display device. This prevents the display device from tilting downward due to gravity when the adjustment rod 34 is in an unlocked state for adjusting the tilt angle between the first structural member 31 and the second structural member 32.

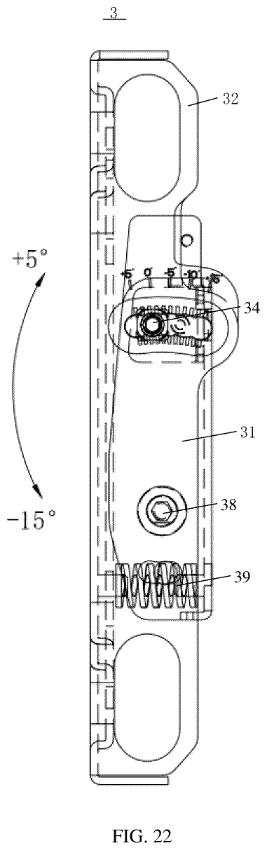

Referring to FIG. 22, FIG. 22 illustrates a range of tilt angles between the second structural member 32 and first structural member 31, specifically from +5 degrees to −15 degrees.

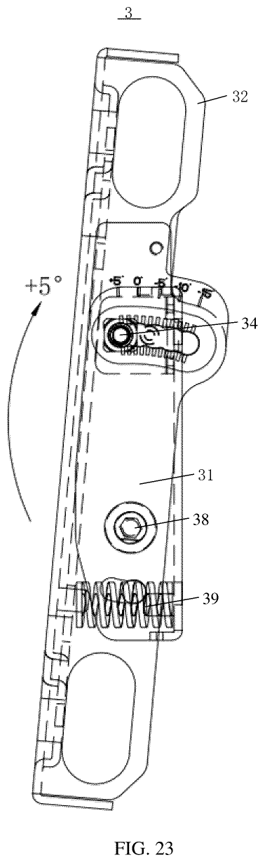

Referring to FIG. 23, FIG. 23 illustrates the second structural member 32 tilted upward 5 degrees relative to the first structural member 31. As shown in FIG. 23, when the second structural member 32 is tilted upward by 5 degrees relative to the first structural member 31, the second structural member 32 and its display device should be in an upward-tilted state.

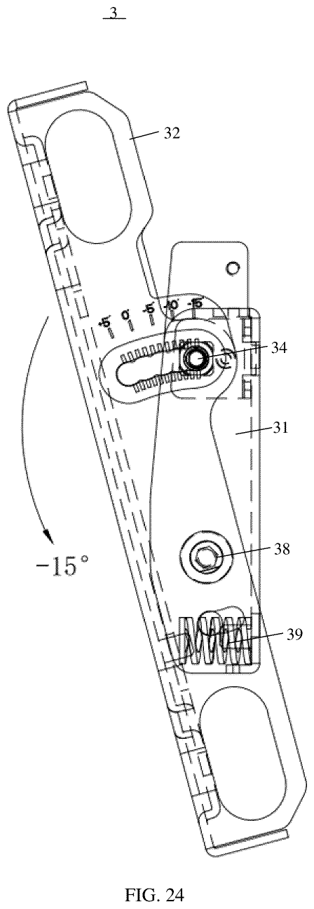

Referring to FIG. 24, FIG. 24 illustrates the second structural member 32 tilted downward 15 degrees relative to the first structural member 31. As shown in FIG. 24, when the second structural member 32 is tilted downward by 15 degrees relative to the first structural member 31, the second structural member 32 and its display device should be in a downward-tilted state.

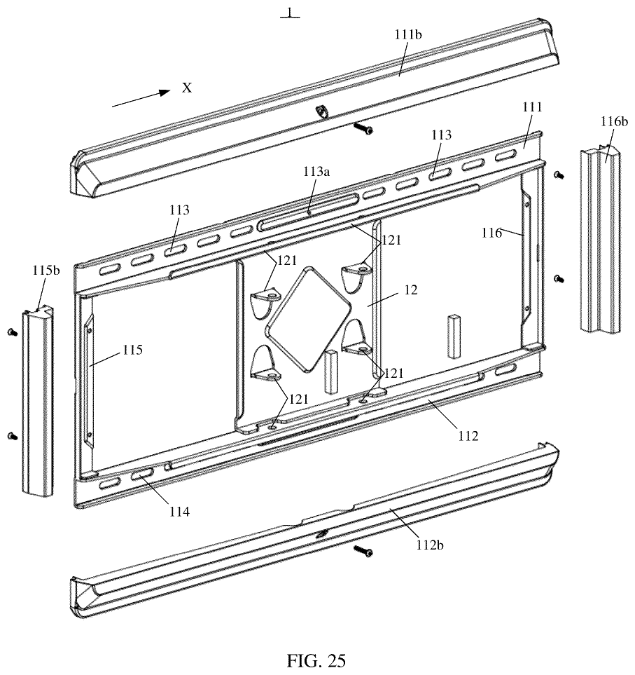

Referring to FIG. 25, FIG. 25 is an exploded view of a wall plate 1 according to embodiments of the present disclosure. As shown in FIG. 25, the cross-sections of the upper wall plate 111 and the lower wall plate 112 are U-shaped. The upper wall plate 111 defines a plurality of horizontally arranged strip-shaped first mounting holes 113 spaced apart along the X-axis direction. The first mounting holes 113 are symmetrically arranged relative to the center of the upper wall plate 111. The upper wall plate 111 further defines a first center hole 113a at its center position, marking the center of the upper wall plate 111. Similarly, the lower wall plate 112 defines a plurality of horizontally arranged strip-shaped second mounting holes 114 spaced apart along the X-axis direction. The second mounting holes 114 are symmetrically arranged relative to the center of the lower wall plate 112. The lower wall plate 112 further defines a second center hole at its center position, marking the center of the lower wall plate 112.

The rectangular frame 11 can further include a first vertical plate 115 and a second vertical plate 116. The two ends of the first vertical plate 115 are connected to one end of the upper wall plate 111 and one end of the lower wall plate 112, respectively. The two ends of the second vertical plate 116 are connected to the other end of the upper wall plate 111 and the other end of the lower wall plate 112, respectively.

The wall plate 1 can further include a first protective cover 111b corresponding to the upper wall plate 111, a second protective cover 112b corresponding to the lower wall plate 112, a third protective cover 115b corresponding to the first vertical plate 115, and a fourth protective cover 116b corresponding to the second vertical plate 116. The first protective cover 111b is slope-shaped and connected to the upper wall plate 111 to fully cover the upper wall plate 111. The second protective cover 112b is slope-shaped and connected to the lower wall plate 112 to fully cover the lower wall plate 112. The third protective cover 115b is slope-shaped and connected to the first vertical plate 115 to fully cover the first vertical plate 115. The fourth protective cover 116b is slope-shaped and connected to the second vertical plate 116 to fully cover the second vertical plate 116.

The connecting plate 12 can include connecting assemblies 121 each for one rear support arm 21. Each connecting assembly 121 can include an upper lug plate and a lower lug plate. One end of the rear support arm 21 is inserted between the two lug plates and connected via a corresponding screw assembly. In this embodiment, one of the two lug plates may be formed by a flange on the upper wall plate 111 or the lower wall plate 112, allowing the wall plate 1 to be more compact in the height direction.

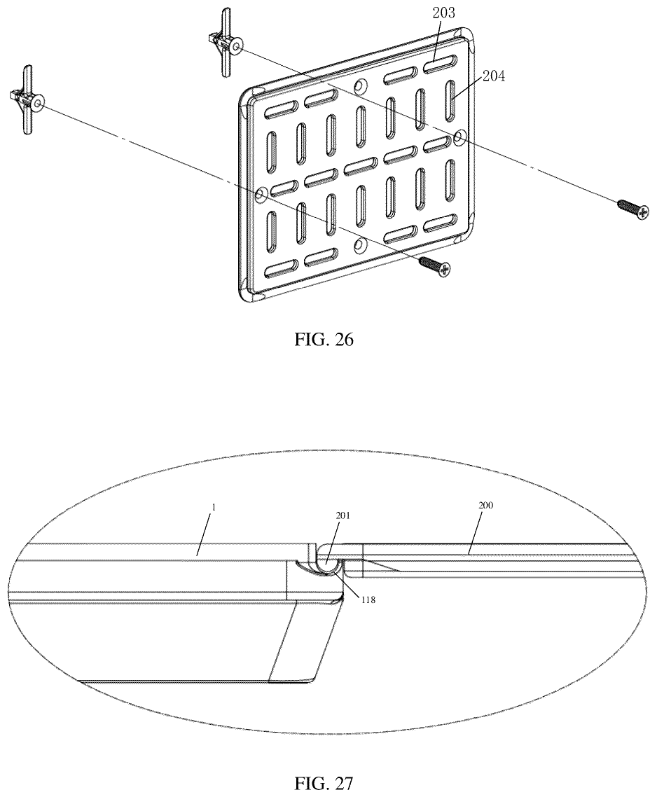

Referring to FIG. 26, FIG. 26 is a structural and installation view of a multimedia plate 200 according to embodiments of the present disclosure. As shown in FIG. 26, the multimedia plate 200 can include a plurality of horizontal strip holes 203 and a plurality of vertical strip holes 204 for installing clips to hold devices such as set-top boxes, remote controls, and optical modems. Generally, the multimedia plate 200 can be fixed to the wall by tightening two screws.

Referring to FIG. 27, FIG. 27 is a schematic view showing an interlocking connection between the multimedia plate 200 and wall plate 1 according to embodiments of the present disclosure. As shown in FIG. 27, the wall plate 1 defines a clamping groove 118 on its wall-facing side at the edge, while the multimedia plate 200 can include a clamping protrusion 201 on its outward-facing side at the edge. The shapes of the clamping groove 118 and the clamping protrusion 201 are complementary, allowing the wall plate 1 to engage with the clamping protrusion 201 of the multimedia plate 200 via the clamping groove 118. Therefore, the multimedia plate 200 only requires one additional screw for fixation.

It is understandable that in at least one embodiment, the clamping groove 118 may be defined on the edges of the upper wall plate 111, lower wall plate 112, first vertical plate 115, or second vertical plate 116. In other embodiments, the clamping groove 118 may be defined on the edges of the first protective cover 111b, second protective cover 112b, third protective cover 115b, or fourth protective cover 116b, which is not limited herein.

As shown in FIG. 27, both the clamping groove 118 and the clamping protrusion 201 are semicircular in shape.

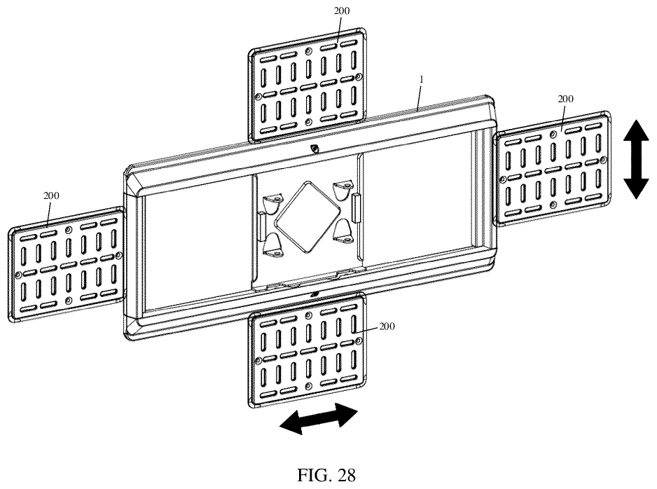

Referring to FIG. 28, FIG. 28 is a schematic view showing the interlocking connection between the multimedia plate 200 and different edges of the wall plate 1 according to embodiments of the present disclosure. As shown in FIG. 28, the multimedia plate 200 can engage with any of the top, bottom, left, or right edges of the wall plate 1.

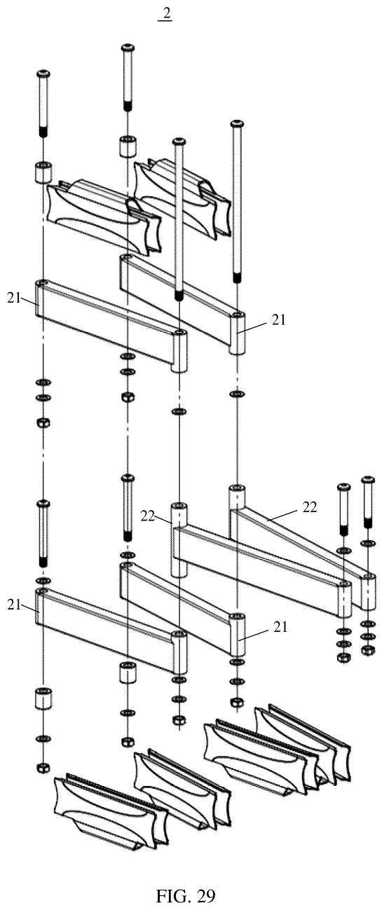

Referring to FIG. 29, FIG. 29 is an exploded view of a support arm 2 according to embodiments of the present disclosure. It can be seen that the mounting bracket 100 can include two support arms 2. Each support arm 2 can include two rear support arms 21 and one front support arm 22. The ends of the two rear support arms 21 are pivotally connected to different height positions of the connecting plate 12, while the front support arm 22 is pivotally connected at its upper and lower sides to the other ends of the two rear support arms 21.

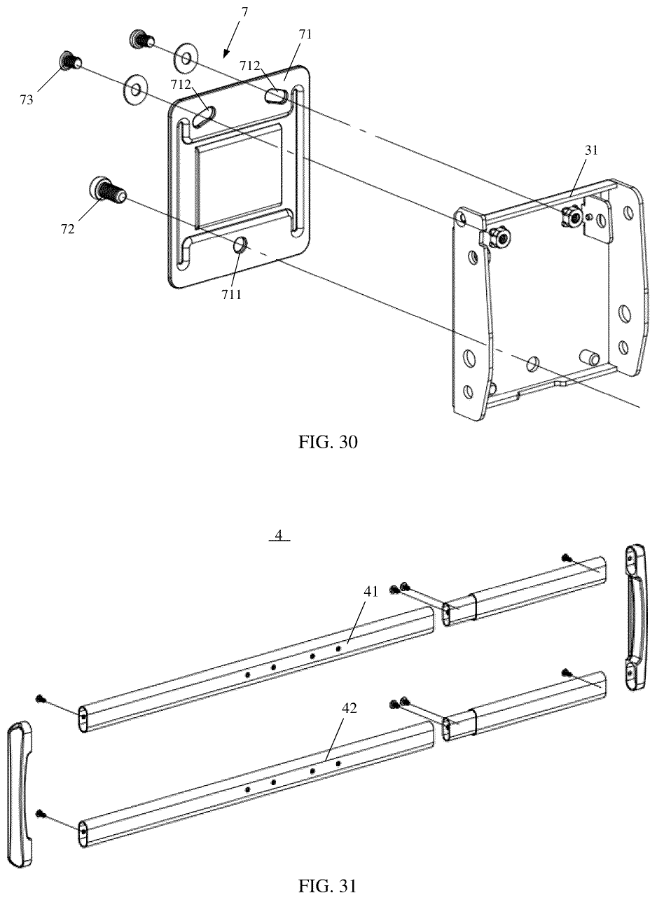

Referring to FIG. 30, in at least one embodiment, the mounting bracket 100 can further include a horizontal adjustment mechanism 7 connected between the tilt adjustment mechanism 3 and the support arm 2 to adjust the levelness of the display device. Specifically, as shown in FIG. 30, the horizontal adjustment mechanism 7 can include a horizontal adjustment plate 71, a first connecting member 72, and a second connecting member 73. One side of the horizontal adjustment plate 71 is connected to the other end of the support arm 2. The horizontal adjustment plate 71 can include a second pivot hole 711 and at least one second arc-shaped hole 712. The second arc-shaped hole 712 is centered on the second pivot hole 711. The first connecting member 72 is connected between the second pivot hole 711 and the first structural member 31, while the second connecting member 73 is connected between the second arc-shaped hole 712 and the first structural member 31.

In this embodiment, there are two second arc-shaped holes 712, spaced apart and both centered on the second pivot hole 711.

As shown in FIG. 30, the horizontal adjustment plate 71 and the first structural member 31 have similar shapes, both being square-plate-like. The horizontal adjustment plate 71 is approximately parallel to the plane of the first plate body 310 of the first structural member 31.

Referring to FIG. 31, FIG. 31 is an exploded view of a panel 4 according to embodiments of the present disclosure. As shown in FIG. 31, the upper horizontal bar 41 and the lower horizontal bar 42 of the panel 4 are segmented and sleeve-connected structures.

Therefore, this segmented sleeve-connected structure can adapt to display devices of different sizes.

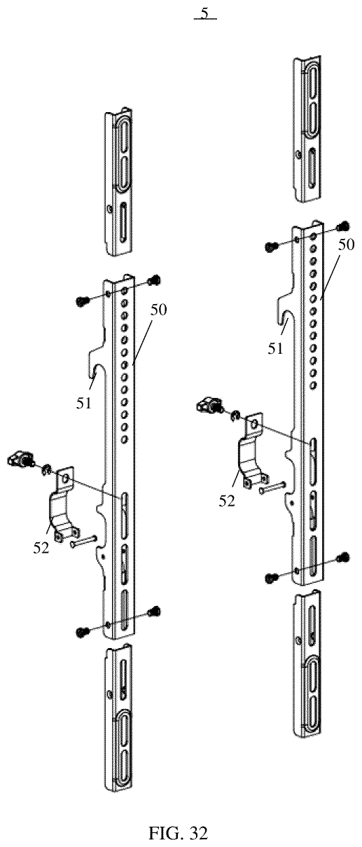

Referring to FIG. 32, the mounting member 5 can include a hanging strip 50 and a locking member 52. The hanging strip 50 can include a hook 51 for hanging on the upper horizontal bar 41. One end of the locking member 52 is rotatably connected to the hanging strip 50 at a position corresponding to the lower horizontal bar 42, while the other end of the locking member 52 can bypass the lower horizontal bar 42 and lock to another position of the hanging strip 50 corresponding to the lower horizontal bar 42.

Therefore, the locking member 52 enables quick locking.

In summary, the mounting bracket 100 of the present disclosure can achieve four-dimensional angle adjustment: movement along the Y-axis (front-rear), movement along the X-axis (left-right), rotation about the X-axis (tilt), and rotation about the Y-axis (swivel).

The above describes the technical solutions and details of the present disclosure. It is understandable that the above description only covers some embodiments of the technical solutions, and some details may be omitted during actual implementation.

Additionally, in at least one embodiment of the present disclosure, multiple embodiments may be combined in practice. Due to space limitations, not all combinations are listed here. Those of ordinary skill in the art can freely combine the above embodiments based on requirements to achieve better application performance.

In conclusion, the present disclosure possesses the aforementioned advantageous features, enabling it to deliver unprecedented performance in practical use, making it a highly practical and valuable product.

The above descriptions are merely preferred embodiments of the present disclosure and are not intended to limit the scope of the application. Any modifications, equivalent substitutions, or improvements made within the spirit and principles of the application shall be included within the protection scope of the application.

What is claimed is:

1. A tilt adjustment mechanism, comprising:
a first structural member, wherein a first sidewall of the first structural member defines a first connection hole and a second connection hole; and
a second structural member, wherein a second sidewall of the second structural member defines a first pivot hole and an adjustment hole;
wherein the adjustment hole comprises at least two adjustment sub-holes arranged along a front-rear direction of the tilt adjustment mechanism, a distance between centers of any two adjacent adjustment sub-holes is smaller than a diameter of a single adjustment sub-hole, with each adjustment sub-hole corresponding to a distinct tilt angle;
wherein the tilt adjustment mechanism further comprises a connecting member and an adjustment rod; the connecting member is connected between the first connection hole and the first pivot hole, and the adjustment rod is penetrated between the adjustment hole and the second connection hole;
wherein the adjustment rod comprises a flattened portion, the flattened portion comprises a cylindrical surface and two planes located on opposite sides of the cylindrical surface respectively; a diameter of the cylindrical surface is equal to a diameter of each of the adjustment sub-holes, and a distance between the two planes is less than or equal to a width of a connecting portion between two adjacent adjustment sub-holes;
wherein when the adjustment rod is rotated to a first position, the adjustment rod is capable of passing through the connecting portion between two adjacent adjustment sub-holes; and
wherein when the adjustment rod is rotated to a second position, the adjustment rod is locked relative to the adjustment hole.

2. The tilt adjustment mechanism according to claim 1, wherein the adjustment hole is an arc-shaped elongated hole centered on the first pivot hole.

3. The tilt adjustment mechanism according to claim 1, wherein arc extensions of two adjacent adjustment sub-holes intersect to form a protrusion.

4. The tilt adjustment mechanism according to claim 1, wherein: the tilt adjustment mechanism further comprises a rotating handle; the rotating handle is located on an outer surface of the second sidewall of the second structural member and non-rotatably connected to the flattened portion of the adjustment rod; and the rotating handle is capable of driving the adjustment rod to rotate between the first position and the second position.

5. The tilt adjustment mechanism according to claim 4, wherein a rotation angle range of the rotating handle is 0 to 90 degrees.

6. The tilt adjustment mechanism according to claim 1, wherein: the adjustment rod further comprises a round rod portion connected to the flattened portion; the tilt adjustment mechanism further comprises a rotation limiting member; the rotation limiting member comprises a rotating member and a limiting post; the rotating member is connected to the round rod portion, and the limiting post is fixed on a surface of the first structural member facing the second structural member; and the rotating member and the limiting post cooperatively limit a rotation angle of the adjustment rod relative to the second structural member.

7. The tilt adjustment mechanism according to claim 6, wherein: the rotation limiting member further comprises a fixing member fixed on a surface of the first structural member facing the second structural member; the fixing member defines a through hole along a length direction of the adjustment rod, and the round rod portion is penetrated into the through hole;
the limiting post is arranged on a surface of the fixing member; the rotating member comprises a first limiting portion and a second limiting portion; when the limiting post engages with the first limiting portion, the adjustment rod is rotated to the first position; and when the limiting post engages with the second limiting portion, the adjustment rod is rotated to the second position.

8. The tilt adjustment mechanism according to claim 7, wherein: the rotating member comprises a ring portion, as well as a first protruding portion and a second protruding portion extending radially outward from two different positions of the ring portion; the first protruding portion and the ring portion cooperatively form the first limiting portion; and the second protruding portion and the ring portion cooperatively form the second limiting portion.

9. The tilt adjustment mechanism according to claim 7, wherein: the tilt adjustment mechanism further comprises an abutting member sleeved on the round rod portion; and two opposite ends of the abutting member abut between the second sidewall of the second structural member and the fixing member.

10. The tilt adjustment mechanism according to claim 1, wherein: an outer surface of the second sidewall of the second structural member comprises a scale marking corresponding to the adjustment hole; the tilt adjustment mechanism further comprises a pointer member connected between the first structural member and the second structural member; and when the first structural member has different tilt angles relative to the second structural member, the pointer member cooperates with the scale marking to indicate an tilt angle of the second structural member relative to the first structural member.

11. The tilt adjustment mechanism according to claim 10, wherein: the pointer member comprises a connection portion, a spanning portion, and an indicator arrow; the connection portion is connected to the first structural member, the spanning portion is connected between the connection portion and the indicator arrow, and the spanning portion is spanned across the first sidewall of the first structural member and the second sidewall of the second structural member where the adjustment hole is located; and the indicator arrow is located on the outer surface of the second sidewall of the second structural member where the adjustment hole is located and points to the scale marking.

12. The tilt adjustment mechanism according to claim 11, wherein: the spanning portion is U-shaped, and the connection portion is perpendicularly connected to one arm of the spanning portion; and the connection portion is connected to a top surface of the second structural member.

13. The tilt adjustment mechanism according to claim 10, wherein: the pointer member is a ratchet mechanism, the pointer member comprises a spring-loaded pin assembly and an engagement member; the engagement member is fixed on the second sidewall of the second structural member and comprises at least two engagement teeth, each corresponding to a different tilt angle; the spring-loaded pin assembly is fixed on the first sidewall of the first structural member; and when the second structural member has different tilt angles relative to the first structural member, the spring-loaded pin assembly engages with the corresponding engagement teeth to indicate the tilt angle of the second structural member relative to the first structural member.

14. The tilt adjustment mechanism according to claim 13, wherein: the spring-loaded pin assembly comprises an elastic abutment member and a pin; one end of the elastic abutment member is fixed on the first sidewall of the first structural member, and the other end of the elastic abutment member is connected to one end of the pin; and one end of the pin facing the engagement teeth engages with the corresponding engagement teeth.

15. The tilt adjustment mechanism according to claim 13, wherein both the engagement teeth and an end of the pin facing the engagement teeth are sharp-angled.

16. The tilt adjustment mechanism according to claim 14, wherein: the elastic abutment member comprises a spring seat and a first spring; the spring seat is fixed on the first sidewall of the first structural member; the spring seat defines a receiving groove and an abutment post inside the receiving groove on one side facing an inside surface of the first sidewall of the first structural member; the pin defines an elongated hole extending along a height direction of the tilt adjustment mechanism, and the abutment post is inserted into the elongated hole; and the first spring is also located in the elongated hole and abuts between the abutment post and a top end of the elongated hole.

17. The tilt adjustment mechanism according to claim 1, wherein: openings of the first structural member and the second structural member face each other; the tilt adjustment mechanism further comprise a pivot shaft rotatably connected between the first sidewall of the first structural member and the second sidewall of the second structural member; the tilt adjustment mechanism further comprises an elastic support member arranged between the first structural member and the second structural member; and the elastic support member and the adjustment rod are located on opposite sides of the pivot shaft, and an elastic restoring force of the elastic support member is configured to offset at least part of gravity of a display device.

18. A mounting bracket, wherein the mounting bracket comprises a wall plate, a support arm, a tilt adjustment mechanism according to claim 1, a panel, and a mounting member;
wherein:
the wall plate is configured for mounting on a wall;
one end of the support arm is pivotally connected to the wall plate;
the tilt adjustment mechanism is connected between the other end of the support arm and the panel; and
the mounting member is configured for fixedly connecting to a back of a display device and hanging on the panel.

19. The mounting bracket according to claim 18, wherein: the mounting bracket further comprises a horizontal adjustment mechanism, the horizontal adjustment mechanism comprises a horizontal adjustment plate, a first connecting member, and a second connecting member; one side of the horizontal adjustment plate is connected to the other end of the support arm; the horizontal adjustment plate defines a second pivot hole and an arc-shaped hole centered on the second pivot hole; and the first connecting member is connected to the first structural member through the second pivot hole, and the second connecting member is connected to the first structural member through the arc-shaped hole.

20. The mounting bracket according to claim 18, wherein an edge of the wall plate defines at least one clamping groove, each clamping groove is configured for engaging with a clamping protrusion on an edge of a multimedia plate, and/or the clamping groove is semi-circular in shape.
